(19) United States
(12) Patent Application Publication
(10) Pub. No.: US 2014/0071293 A1
(43) Pub. Date: Mar. 13, 2014

(54) METHOD AND DEVICE FOR AUTHINTICATION OF LIVE HUMAN FACES USING INFRA RED IMAGES

(71) Applicant: Ranjith UNNIKRISHNAN, Mountain View, CA (US)

(72) Inventor: Ranjith UNNIKRISHNAN, Mountain View, CA (US)

(73) Assignee: GOOGLE INC., Mountain View, CA (US)

(21) Appl. No.: 13/611,977

(22) Filed: Sep. 12, 2012

(51) Int. Cl. H04N 5/33

(52) U.S. Cl. 348/164; 348/E05.09

(57) ABSTRACT

A security device for identifying a person makes two images of a person to detect spoofing. The first image is a conventional visible image and the second image is an infrared image. Both images are analyzed to determine whether they represent a real person or not. If a placard or active display device is presented to the security device to spoof the real person, the infrared image of the placard or display device is recognized not to have the same characteristics as the infrared image of a real person.

### BACKGROUND

A. Field

This disclosure pertains to a system for identifying a person using face recognition, and more particularly, to a system and method in which, in addition to a standard image of the person's face, an infra-red (IR) image is also obtained for confirmation.

B. Description of the Prior Art

There are many instances in which it is necessary and important to identify a person using an automated device. For example, ATMs must be able to determine that a person using a debit or credit card is really a customer authorized to access a bank account or not. An airline ticket dispenser at an airport must be able to verify that a person trying to obtain or confirm an airline ticket is the identified traveler, or not. Some entities, such as banks, use automated doors or other gateways that provide access to certain rooms or premises only to authorized personnel. The standard means of identifying persons by such automated devices has been to provide such persons with some kind of electronic card. In order to activate the device (e.g., gain access to an account, obtain a ticket, gain entry through a door, etc.) a person had to insert the card into a card reader. Over time, it was found that the electronic card could be duplicated or otherwise compromised and a secondary authentication means was also provided. For example, the person had to enter a secret code on a keyboard and/or place a finger on a fingerprint reader, etc.

However, none of the systems described above are foolproof and therefore other authentication means have been proposed, many of which relied on biometrics. For example, devices have been provided with a camera for taking a standard, visible image of a person trying to activate a device. The visible image was then analyzed using face recognition techniques and compared to a reference image previously taken of the person. (The term “image” is used herein to refer to both still pictures and videos). Of course, this technique can be circumvented by an imposter displaying an image of the person.

Alternatively, a system captures a video of a person and then performs facial motion analysis on the video to test for a live face. However, such security systems can be similarly compromised by an unauthorized user presenting the camera with a video of the person having the desired authorization. Moreover, algorithms for detecting live faces in a video are fairly complex.

### SUMMARY

The present disclosure provides a system and method that prevents spoofing. In one example, two images are taken. The first image is a standard image taken in the visible light range. The second image is an IR image. The two images are either taken with the same camera using different filters or by using two different cameras, one being sensitive to visible light and the second being sensitive to radiation in the IR range. The second image is analyzed first to determine if there is a real person standing in front of the camera. This can be done, for example, by determining whether the IR image has a signature generally characteristic of human faces in general. If the IR image is consistent with the IR images of human faces in general then the first image is analyzed using conventional algorithms. In an alternate example, certain predetermined features of the person's face are compared in the two images to determine if there is a correlation, thereby providing further authentication of the person.

In an alternate example, the IR image is analyzed to confirm that has the characteristics associated with human faces.

### BRIEF DESCRIPTION OF THE FIGURES

FIG. 1 shows a diagrammatic side view of a device constructed in accordance with this disclosure and being used by a genuine person;

FIG. 2 shows a similar diagrammatic side view of a device constructed in accordance with this disclosure and being used by an unauthorized person;

FIGS. 3A, 3B 3C shows images obtained by the devices of FIGS. 1 and 2;

FIG. 4 shows a block diagram of a camera used for the device of FIGS. 1 and 2; and

FIG. 5 shows a flow chart for the operation of the device of FIGS. 1-4; and

FIG. 6 shows a flow chart of an alternate implementation of the device.

### DETAILED DESCRIPTION

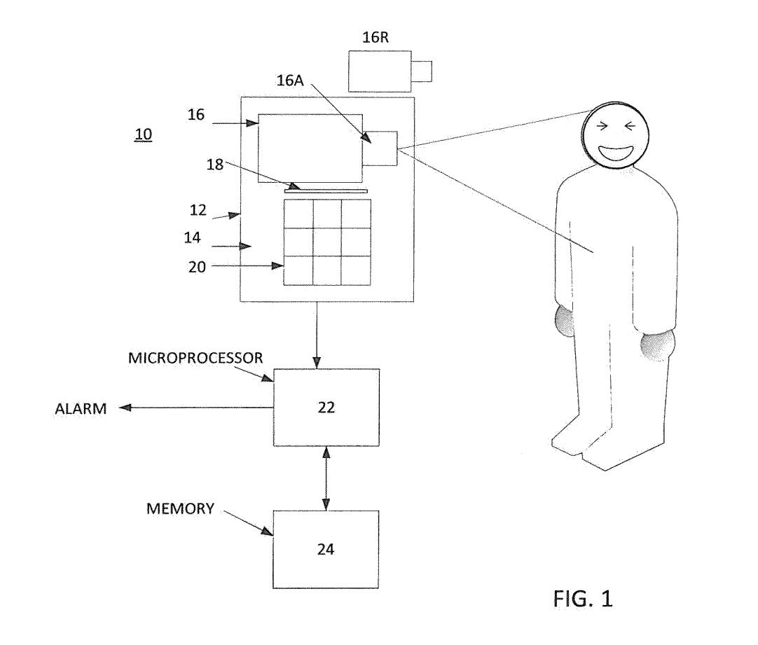

Referring now to FIG. 1, an authentication device 10 in accordance with this disclosure is stationed and is part of a security system used to control access to a restricted area of a facility. The facility is conventionally a part of a private or governmental entity that must assure that only authorized personnel enters the area. However, the present disclosure may also be used to provide access for the general public to venues requiring an entrance fee, such as a sports stadium, a theater, etc. The device 10 includes a housing 12 with a front face 14, a camera 16 and several interfacing components that provide an interface with a person P. This interface includes, for example, a card reader 18 used to read a card or other authorization member (not shown), a keyboard 20, etc. The device 10 further includes a microprocessor 22 and a memory 24.

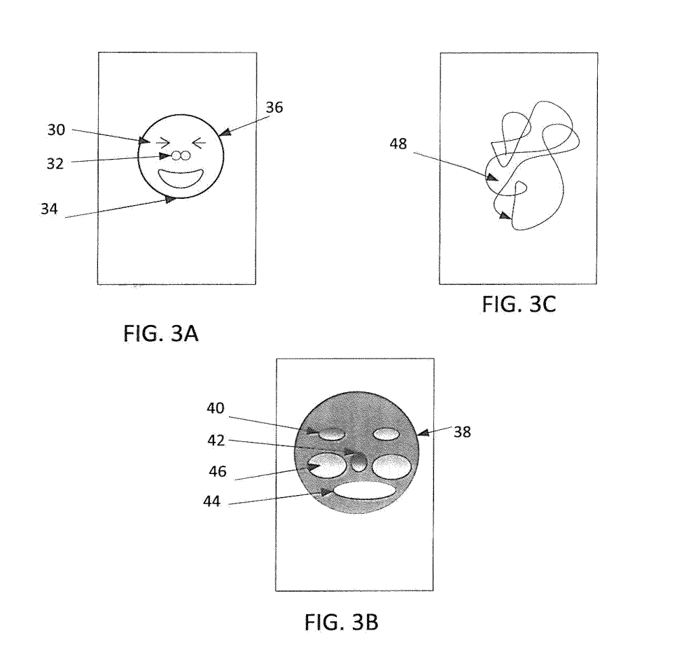

It should be understood that the camera 16, microprocessor 22 and memory 24 may but need not be disposed in the same housing 12 as the interfacing components. The camera 16 must be directed so that its optical element 16A is directed at the person P (preferably his or her face) and images are obtained of the person, such as images shown in FIGS. 3A-3C described more fully below.

Preferably, the camera 16 is used to obtain a normal image (e.g., an image generated using light in the visible range) and an IR image (e.g., an image generated using electromagnetic radiation in the infrared range). Optionally, other types of electromagnetic radiation may be used to generate images as well. Conventional cameras, especially digital cameras, are made with sensors that are sensitive to radiation in the range that extends beyond the visible light, including at least a substantial portion of the IR range. It has been found that using images obtained from such sensors creates various undesirable effects, such as undesirable color artifacts. Therefore, it is very common to provide such cameras with filters that restrict the range of the sensors to the visible light range.

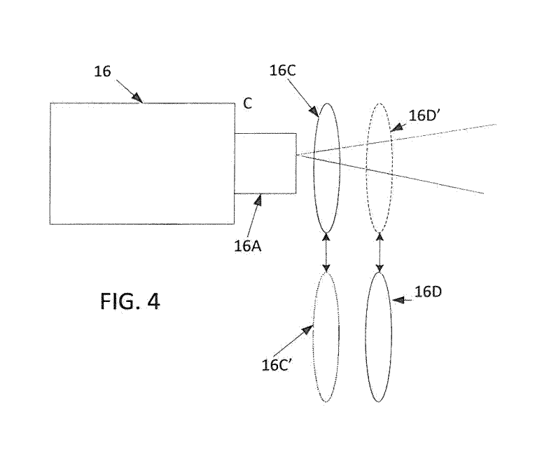

For example, as shown in FIG. 4, camera 16 is frequently provided with an IR filter 16C that passes visible light but blocks IR radiation. In the present disclosure, camera 16 is used with filter 16C blocks IR radiation and is substantially transparent to visible light. Filter 16C is used in front of the optical element 16A. To take an IR image, the IR filter 16C is shifted to position 16C′ away from the field of view of element 16A, and a visible light filter 16D is shifted to position 16D′ as shown. Filter 16D blocks visible light and is substantially transparent to IR radiation. Of course, it should be understood that alternatively optical filters 16C, 16D, can be implemented electronically by performing data processing on the output of the camera 16.

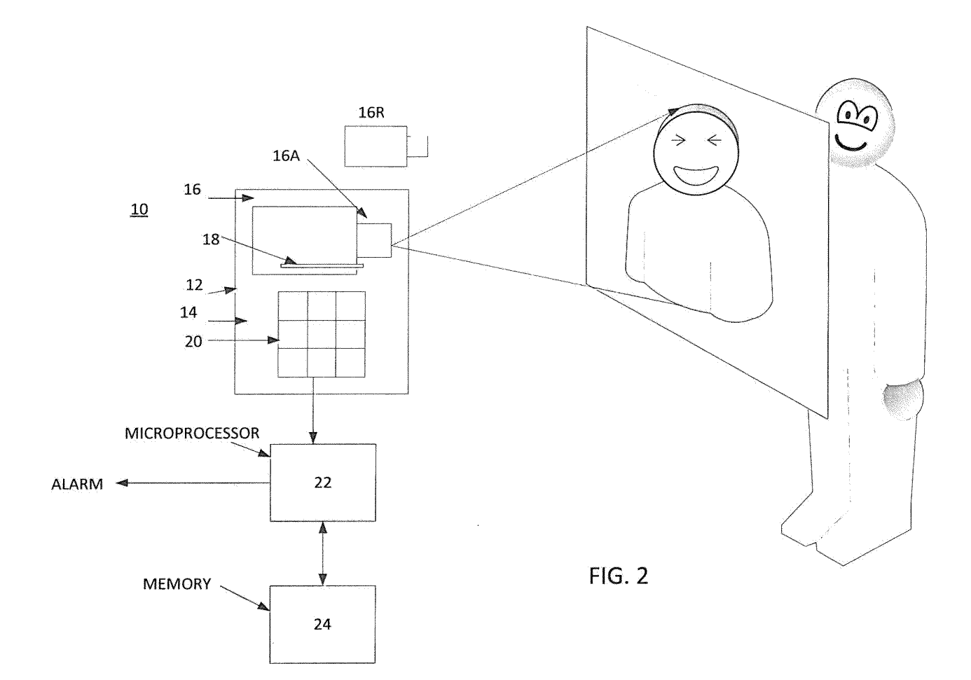

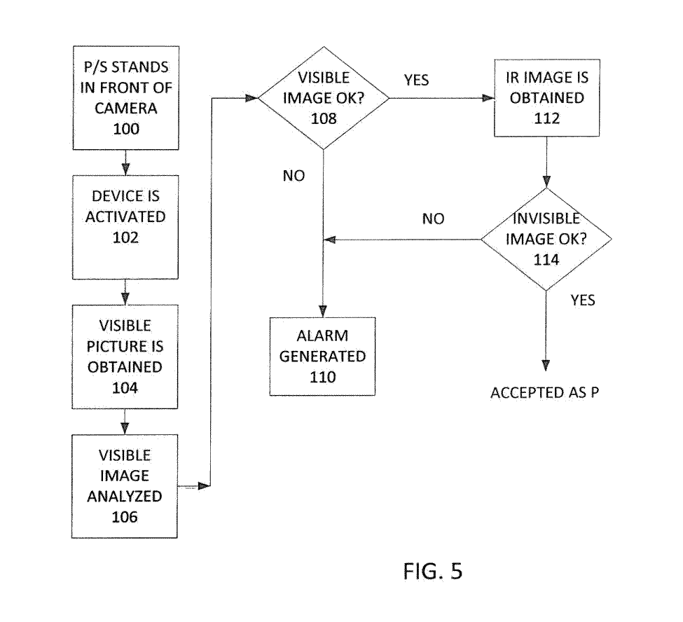

Referring now to FIGS. 1-5, a person P uses the device 10 as follows. In step 100, he approaches the device 10 and positions himself in the field of view of camera 16. In step 102 the device 10 is activated. This activation may take place automatically, for example by detecting the presence of person P either through the camera 16, or through other means such as a proximity sensor (not shown) or a mechanical switch (not shown). The activation may also occur manually, with the person P either inserting an authorization card into card reader 18, by activating a switch on the keyboard 20, by entering a code on the keyboard 20, etc.

In step 104 a visible image is taken by camera 16 and the visible image is sent for processing to the microprocessor 22. In step 106 the visible image is analyzed using well known face recognition techniques. FIG. 3A shows (diagrammatically) a visible image 36 of person P. FIG. 3B shows an IR image 38 of the person P. As can be seen in these figures, the visible image 36 includes several well-known characteristic features such as the eyes 30, nose 32, mouth 34, etc. The image 38 also includes several characteristic features having very definite shapes, such as the eyes 40, nose 42, mouth 44 or cheeks 46 disposed close to the nose 42. While some of the features match the visible features, others do not. The various features characterizing the visible image 36 are determined in step 106.

In step 108 a decision is made as to whether the visible image 36 is accepted or not. This step can be accomplished in many different ways. For example, a plurality of reference images of acceptable or authorized people may be stored in memory 24 and, in step 108 a known optical recognition algorithm is used to compare the images from memory 24 with the visible image of P, using features 30, 32, 34. Alternatively, when a person has an identification card, a reference Image may be stored in the identification card and provided to microprocessor 22 by the card reader 16. Many other methods for identifying or authenticating the person P from his image 36 can be used as well.

If the image 36 is not recognized, then an alarm or some other audible, visual signal is generated and/or a message is sent to a remote location indicating this event.

If the visible image is recognized in step 108 then a validation process is performed as follows. In step 112 an IR image of the person standing in front of camera 16 is taken. In one implementation of the disclosure this is accomplished by having filters 16C and 16D automatically shift to positions 16C′ and 16D′ respectively (if necessary). The IR image is also sent to the microprocessor 22 for processing to identify some characteristic features, such as zones 40, 42, 44 and 46. If no optical filters 16C, 16D are used, then IR image 38 is obtained by the microprocessor (or by other digital signal processing equipment) from the raw image obtained from the camera 16.

As previously mentioned, step 108 can be defeated by a person S who is masquerading as person P. For example, when person S is positioned in the field of view of camera 16, he may hold up or hide before a placard 50 with an image 52 of person P. In this situation, when the microprocessor 22 analyzes the image 52, it will most likely erroneously recognize it as a true image 36 of person P. In an alternate implementation of the disclosure, instead of a placard with an image 52, the person S may hold up a portable screen on which either a still image 52 or a short video clip is presented to camera 16. The camera 16 may use either a still image of P as the reference or a video clip.

In yet another, more elaborate example, if conditions permit, person S may hold up a blank screen and the fake image 52 or video clip can be projected on the screen by an image projector (not shown) or by directly presenting the security camera with a display screen.

In any case, when camera 16 takes an IR picture of the placard 50, the resulting IR image is either blank or consists of some indeterminate shape 48 (FIG. 3C) that looks nothing like the image 36.

The IR image obtained by camera 16 is analyzed in step 112. This step can be implemented in several different ways. In one implementation, the IR image recorded by camera 16 (e.g., either 38 or 48) is analyzed to determine whether it is an actual IR image of a person or not. This may be done in the crudest sense by determining whether the IR image (if any) includes a shape having the dimensions similar to a typical human head or by determining if the color (or shade) of the IR image is in predetermined range, since this color is related to the temperature of the object being imaged.

A more substantive test includes looking for and detecting various other known features of a human face. For example, because of temperature variations, the image of human face may include several zones (See FIG. 3B), such as zone 40 corresponding to the location of the eyes, zone 42 corresponding to the nose, zone 44 corresponding to the mouth, or zone 46 corresponding to the cheeks. In one example, the sizes, positions and/or colors or shades (especially for a monochromatic image) are determined and compared to known characteristics of a standard human face.

In another example, instead of comparing zones of image 36 to standard human faces, specific characteristics of the image 36 are compared to known characteristics of person P's face as recorded in memory 24 or on the authorization card inserted into card reader 18. If the characteristics match, image 38 is considered genuine.

The test for detecting an IR image of an actual person P as opposed to a spoofing person S is performed in step 114. If the IR image is recognized, then the person is accepted as person P. If the IR image is not recognized then an alarm is generated in step 110.

As discussed above, most digital cameras have a wide responsive range that covers the visible light and IR range. Therefore a single camera 16 can be used to obtain images 36, 38, 48 using either analog or digital filtering. Alternatively, two different cameras 16, 16R may be used to record the images of FIGS. 3A, 3B, 3C.

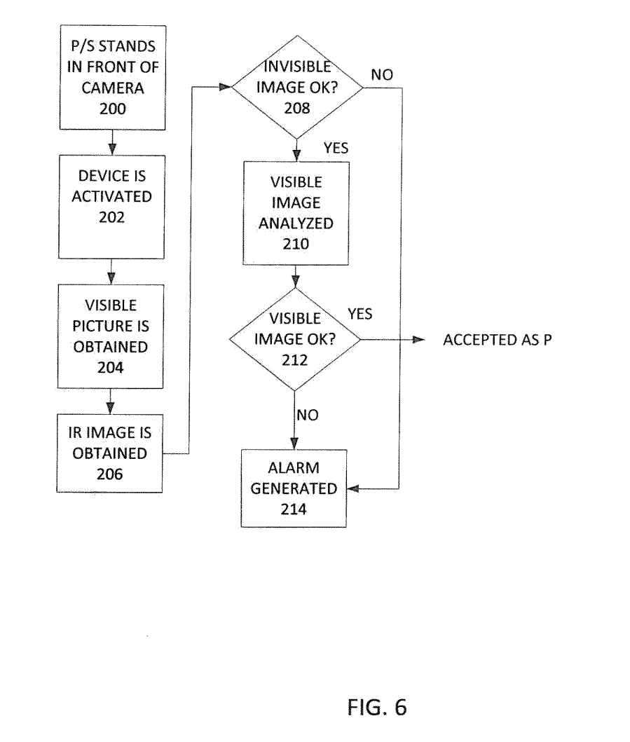

Depending on various considerations, the visible and IR images may be taken and/or analyzed in the reverse order to the one described above, or even simultaneously. For example, in the implementation of FIG. 6, a person stands in front of the camera (step 200) causing the device to be activated (step 202), the visible and IR images are taken (steps 204, 206). The IR image is checked (step 208) and only if it is acceptable, is the visible image checked (steps 210, 212). If both images pass the inspection (steps 208, 212) the person is accepted as P, otherwise an alarm is generated (step 214).

Numerous modifications may be made to the disclosure without departing from its scope as defined in the appended claims.

We claim:

1. An apparatus for authorizing a person to gain access to a facility or machine comprising:
an image detector adapted to generate a visible and an IR image of the person; and
an analyzer receiving said images and being adapted to analyze said images to determine if both images have characteristics indicative of an actual person.

2. The apparatus of claim 1 wherein said image detector includes a camera adapted to generate said images.

3. The apparatus of claim 2 further comprising at least one of a visible filter being substantially transparent to visible light and blocking IR radiation and a second filter being substantially transparent to IR radiation and blocking visible light.

4. The apparatus of claim 2 wherein said image detector includes a first camera detecting said visible image and a second camera detecting said IR image.

5. The apparatus of claim 1 further comprising a memory storing at least one of visible and IR stored characteristics and wherein said analyzer determines image characteristics and compares them to said stored characteristics.

6. The apparatus of claim 1 wherein said analyzer is adapted to detect an IR image characteristic from said IR image and determine from said IR image characteristic whether the IR image was taken of a real person.

7. The apparatus of claim 1 wherein said analyzer is adapted to detect image characteristics in said visible and said IR images and to compare said characteristics.

8. A method of detecting a real person by a security device comprising the steps of:
taking a visible image by the security device;
taking an IR image by the security device;
making a determination by the device that each of the images correspond to and is indicative of a genuine person rather than a spoofed image; and
generating an alarm if the images do not correspond to a genuine person.

9. The method of claim 8 wherein said images are taken sequentially.

10. The method of claim 8 wherein said images are taken simultaneously.

11. The method of claim 8 wherein said IR image is compared to standard IR images of persons to determine if the IR image corresponds to a genuine person.

12. The method of claim 8 wherein said determining step includes detecting particular zones in at least one of said visible and IR images,

13. The method of claim 8 wherein said determining step includes measuring at least a portion of the IR image to detect a real person.
